(19) United States
(12) Patent Application Publication
(10) Pub. No.: US 2026/0100967 A1
(43) Pub. Date: Apr. 9, 2026

(54) TRACKING AND NETWORK RISK MANAGEMENT OF INFORMATION TECHNOLOGY ASSETS AND SYSTEMS

(71) Applicant: JPMorgan Chase Bank, N.A., NEW YORK, NY (US)

(72) Inventors: Julie Christine Zwayer, Columbus, OH (US); Philip J. McCall, Glasgow (GB); Tarun Shukla, Lucknow (IN); Felix Glazer, Brooklyn, NY (US); Dean Ralph, Claygaate (GB); Kathleen Cebulka, Danville, PA (US); Stephen Marchiano, Kinnelon, NJ (US); Kasipathi Bendalam, Hyderabad (IN); Kasi Ammu, Chandanagar (IN)

(73) Assignee: JPMorgan Chase Bank, N.A., NEW YORK, NY (US)

(21) Appl. No.: 19/327,459

(22) Filed: Sep. 12, 2025

(30) Foreign Application Priority Data
Oct. 3, 2024 (IN) 202411074624

(51) Int. Cl. H04L 9/40

(52) U.S. Cl. CPC H04L 63/1433

(57) ABSTRACT

Apparatus is provided including a risk management processing circuit, a control circuit, and assessment data storage. The risk assessment processing circuit is configured to access network element key features, and configured to provide, based at least in part on the accessed key features, assessment data associated with at least select ones of network elements forming a given managed information technology network. The control circuit is configured to cause controls pertaining to at-risk network elements to be placed on the network in accordance with the assessment data. The assessment data storage is configured to hold the assessment data associated with the assessed network elements.

### CROSS REFERENCE TO RELATED APPLICATIONS

This application claims priority to Indian Application No. 202411074624, filed Oct. 3, 2024, which is included herein by reference in its entirety.

### FIELD OF THE DISCLOSURE

The present disclosure relates to determining and managing network risks among a collection of information technology assets. More particularly, the present disclosure relates to assessing network risks associated with information technology assets forming part of a large network.

### BACKGROUND

Information technology (IT) systems, for example, large secure networks, are managed to ensure continuous operation and minimize network risks. Network risks may involve different types of risks. Availability risks involve disruptions to operations, for example, arising from weaknesses in technology, the network, or network devices. Confidentiality risks involve leaking or exposing confidential information. Integrity risks, sometimes referred to as IT data integrity risks, involve data stored or processed by the network that is incomplete, inaccurate, or inconsistent.

A secure network, for example, a financial services network, may have several or more thousand applications that present various risks to the network. It is a challenge to identify the network entities and their associated network risks, so that appropriate controls can be employed to mitigate those risks. Some example controls might include penetration testing and vulnerability scanning.

Some organizations use an upstream classification approach, where manual questionnaires are periodically sent to staff to inquire about risk factors and other data relevant to risk assessment. Responses are collected and used to configure, for example, a ticket handling system. This approach is slow and involves the inefficient use of the organization's technological and system resources.

### SUMMARY

An objective of the present disclosure is to improve on the ability to timely assess risks in an IT network. Further objectives include improving communication and access to information about network resources, providing common controls and systems throughout an organization, and improving the organization's information technology infrastructure. In addition, priorities for protecting the organization's network may be improved, including protecting security and privacy. One or more alternate or additional objectives may be served by the present disclosure, for example, as may be apparent in the following description. Embodiments of the disclosure include any apparatus, machine, system, method, articles (e.g., computer-readable media encoded to cause certain acts), or any one or more sub-parts or sub-combinations of such apparatus (singular or plural), system, method, or article (or encoding thereon or therein), for example, as supported by the present disclosure. Embodiments herein also contemplate that any one or more processes as described herein may be incorporated into a processing circuit.

In accordance with one or more embodiments, one or more apparatus are provided. A risk assessment processing circuit is provided that is configured to access network element key features, and configured to provide, based at least in part on the accessed key features, assessment data associated with at least select ones of network elements forming a given managed information technology network. The risk assessment processing circuit is configured to, for each select network element among plural network elements in the network: (i) access key features pertinent to a set of risk types, (ii) determine an impact score for each of the risk types, (iii) determine an overall score for each of the risk types, and (iv) convert the overall score for each of the risk types to a risk level, and determine the assessment data to include the risk levels converted from the overall scores. A control circuit is provided that is configured to cause controls pertaining to at risk network elements to be placed on the network in accordance with the assessment data. Assessment data storage is provided that is configured to hold the assessment data associated with the assessed network elements.

The apparatus of any preceding clause, wherein the risk assessment processing circuit is further configured to, for each select network element among plural network elements in the network, (v) access key features pertinent to environment factor adjustment for each risk type, (vi) determine an environmental factor adjustment score for respective risk types of at least a subset of the set of risk types, wherein the determined overall score for a given risk type from among each of the risk types is determined based on both the impact score for the given risk type and the environmental factor adjustment score for the given risk type.

The apparatus of any preceding clause, wherein the risk assessment processing circuit is further configured to, for each select network element among plural network elements in the network, (vii) apply minimum risk levels for a given risk type when select accessed key features were utilized to determine a level for the given risk type.

The apparatus of any preceding clause, wherein the network elements further comprise core and non-core assets of the network.

The apparatus of any preceding clause, wherein the assessment data comprises, per assessed network element, feature data representing confidentiality risk type levels.

The apparatus of any preceding clause, wherein the assessment data comprises, per assessed network element, feature data representing integrity risk type levels.

The apparatus of any preceding clause, wherein the assessment data comprises, per assessed network element, feature data representing availability risk type levels.

The apparatus of any preceding clause, wherein the assessment data comprises, per assessed network element, feature data representing overall risk levels.

The apparatus of any preceding clause, wherein the assessment data comprises, per assessed network element, feature data representing confidentiality, integrity, availability, and overall risk levels.

The apparatus of any preceding clause, wherein the risk assessment processing circuit is configured to assess a given core asset comprising an application.

The apparatus of any preceding clause, wherein the application comprises a general ledger application configured to carry out accounting for an organization, wherein when the general ledger application is assessed by the assessment processing circuit to have a high overall risk level, wherein the assessment processing circuit is configured to designate assessment data for the general ledger application to also correspond to a server on which the general ledger application is being run.

The apparatus of any preceding clause, wherein the assessment processing circuit is configured to determine that the overall risk rating for a given network element is critical when any one of the confidentiality, integrity, and availability risk ratings for the given network element is critical.

The apparatus of any preceding clause, further comprising a key feature processor configured to obtain key features from one or more systems of records of the organization, wherein a key feature is a value or value set for an attribute of a given information technology asset and configured to provide the obtained key features required for risk assessment by the risk assessment circuit of a given individual or plural set of network elements.

The apparatus of any preceding clause, further comprising an adjustment processing circuit configured to adjust one or more attributes of the key attributes.

The apparatus of any preceding clause, wherein the adjustment processing circuit is configured to add geopolitical event data as an added key attribute and associated feature.

The apparatus of any preceding clause, further comprising a data change determiner and a data change processing circuit, wherein the data change determiner is configured to determine when a relevant data change has occurred since a last assessment relevant to risk assessment by the risk assessment circuit.

The apparatus of any preceding clause, wherein the data change determiner is configured to determine a relevant data change from an external source external to the given managed information technology network.

The apparatus of any preceding clause, wherein the data change determiner is configured to determine a relevant data change from feedback input from the controls circuit when the controls circuit determines that a given application should be upgraded to a critical rating as a result of a vulnerability scan.

Another exemplary embodiment includes an exemplary method comprising a risk assessment processing circuit accessing network element key features, and providing, based at least in part on the accessed key features, assessment data associated with at least select ones of network elements forming a given managed information technology network. For each select network element among plural network elements in the network: (i) key features are accessed pertinent to a set of risk types, (ii) impact score is determined for each of the risk types, (iii) an overall score is determined for each of the risk types, and (iv) the overall score is determined for each of the risk types to a risk level, and the assessment data is determined to include the risk levels converted from the overall scores. The method also comprises a control circuit causing controls pertaining to at risk network elements to be placed on the network in accordance with the assessment data, and holding, in assessment data storage, the assessment data associated with the assessed network elements.

Yet another exemplary embodiment provides a non-transitory computer-readable media encoded to cause a risk assessment processing circuit accessing network element key features, and providing, based at least in part on the accessed key features, assessment data associated with at least select ones of network elements forming a given managed information technology network. For each select network element among plural network elements in the network: (i) key features are accessed pertinent to a set of risk types, (ii) impact score is determined for each of the risk types, (iii) an overall score is determined for each of the risk types, and (iv) the overall score is determined for each of the risk types to a risk level, and the assessment data is determined to include the risk levels converted from the overall scores. A control circuit causes controls pertaining to at risk network elements to be placed on the network in accordance with the assessment data and holding, in assessment data storage, the assessment data associated with the assessed network elements.

Additional features, modes of operations, advantages, and other aspects of various embodiments are described below with reference to the accompanying drawings. It is noted that the present disclosure is not limited to the specific example embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an embodiment of an organization network with a risk assessment system;

FIG. 2 is a flow chart of an embodiment of a rule-based server process;

FIG. 3 is a flow chart of an embodiment of a risk assessment process;

FIG. 4 is a block diagram showing elements of the system of record (SoR) data shown in FIG. 2;

FIG. 5 is a flow chart of an example embodiment of an attribute adjustment process;

FIG. 6 is a flow chart of an example embodiment of a data change process;

FIG. 7 is a flow chart of an example embodiment of a risk assessment determination process;

FIG. 8 is a block diagram of an example computer controller; and

FIG. 9 is a flow chart of aspects of an exemplary method carried out by a risk assessment system, for example, the system shown in FIG. 1.

To facilitate understanding, identical reference numerals have been used, where possible, to designate identical elements that are common to the figures. It is contemplated that elements disclosed in one embodiment may be beneficially utilized in other embodiments without specific recitation.

### DETAILED DESCRIPTION

In the following, reference is made to example embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

In accordance with one or more embodiments herein, various terms may be defined as follows.

Application or application program: An application program is a program that, when executed, performs a task for another program or user, whereas an operating system program, when executed, serves as an interface between an application program and the underlying hardware of a computer. Any one or more of the various acts described below may be carried out by a program, e.g., an application program and/or operating system program.

Attribute: A variable, for example, a quantitative or qualitative characteristic of an item. See “feature” below. As an example, “color” is an attribute, while “color is blue” is a feature.

Device or network device: An IT asset that is an entity on a network, which entity may be a hardware device, a process, a program, or a mix of one or more hardware devices and one or more processes running on one or more hardware devices (e.g., with distributed processing). Examples of devices include computers, servers, routers, switches, software, virtual entities, and mobile devices. Also, a device or network device may be a virtualized physical resource, for example, software running on one or more servers for carrying network control and/or data transfer. The network or portions of the network may be one or a plural set of software-defined networks.

Disruption: A disturbance or problem with an IT network that interrupts an event, activity, or process.

Feature: A value or information of an attribute. See “attribute” above. As an example, “color” is an attribute, while “color is blue” is a feature.

IT network or network: An interconnection of devices using connection-oriented and/or connectionless, usually encapsulated, communications, for example, with frame relay and other types of encapsulation protocols, in the form of one or more layers. A software-defined network is a type of IT network.

Network element: An element forming part of an interconnected IT network.

Processing circuit: A processing circuit (or circuit) may include both (at least a portion of) computer-readable media carrying functional encoded data and components of an operable computer. The operable computer is capable of executing (or is already executing) the functionally encoded data and thereby is configured when operable to cause certain acts to occur. A processing circuit may also include: a machine or part of a machine that is specially configured to carry out a process, for example, any process described herein; or a special purpose computer or a part of a special purpose computer.

A processing circuit may also be in the form of a general-purpose computer running a compiled, interpretable, or compilable program (or part of such a program) that is combined with hardware carrying out a process or a set of processes. A processing circuit may further be implemented in the form of an application-specific integrated circuit (ASIC), part of an ASIC, or a group of ASICs. A processing circuit may further include an electronic circuit or part of an electronic circuit. A processing circuit does not exist in the form of code per se, software per se, instructions per se, mental thoughts alone, or processes that are carried out manually by a person without any involvement of a machine.

Program: A program includes software for a processing circuit.

User interface tools; user interface elements; output user interface; input user interface; input/output user interface; and graphical user interface tools. User interface tools are human user interface elements that allow human user and machine interaction, whereby a machine communicates to a human (output user interface tools), a human inputs data, a command, or a signal to a machine (input user interface tools), or a machine communicates, to a human, information indicating what the human may input, and the human inputs to the machine (input/output user interface tools).

Graphical user interface tools (graphical tools) include graphical input user interface tools (graphical input tools), graphical output user interface tools (graphical output tools), and/or graphical input/output user interface tools (graphical input/output tools). A graphical input tool is a portion of a graphical screen device (e.g., a display and circuitry driving the display) configured to, via an on-screen interface (e.g., with a touchscreen sensor, with keys of a keypad, a keyboard, etc., and/or with a screen pointer element controllable with a mouse, toggle, or wheel), visually communicate to a user data to be input and to visually and interactively communicate to the user the device's receipt of the input data.

Per one embodiment of the present disclosure, technology assets across a network are reviewed through available data for these assets. The data is available in a variety of systems of record (SoRs), and can be broadly categorized into technology reference data, business impact data, data management SoRs, resiliency data, etc.

Four risk pillars-cyber, technology, data, and governance, are taken into account based on, among other information, an understanding of the overall risk landscape within each area, the organization's current risk management strategies, open issues in an operational risk management system, regulatory & data localization requirements, and industry standards. These pillars provide meaningful insights into an organization's risk posture to application risk classification governance and product teams. This information helps to identify risks against the assets being used within the organization's network, and pinpoint relevant data points that can be used to quantify the inherent risk for each of the assets.

Based on these inputs and additional factors, for example, consultations with experts within each of the risk pillars and/or automated determinations based on these inputs and other factors, a risk assessment may be performed for each asset.

For example, appropriate attributes may be identified under each of the three dimensions of the inherent risk, i.e., attributes under confidentiality, integrity, and availability. These attributes may be configured to be data points from an approved SoR which may be automatically populated in the asset's profile. Each of the data points may have an appropriate owner assigned who must approve the data source.

These technology assets may be assigned confidentiality, integrity, and availability ratings which translate into an overall risk rating of that asset. The inherent risk of an asset (e.g., an application) and its confidentiality, integrity, and availability ratings thus obtained can be used to determine whether the application is in scope of a particular control within the control domain.

This approach to risk-rate assets is agile, and simplifies the way the calculation can be adjusted by adding in or removing with case data points from approved SoRs that matter to the network's overall inherent risk. One just needs to determine the area of risk it is going to impact and the associated scoring in consultation with the risk pillars.

SoRs can easily be added, and if there is a network-wide concern or vulnerability, it can be captured in the inherent risk (optionally with additional attributes). For example, if there a geopolitical event, the process can be easily adjusted by adjusting or adding one or more fields and associated attributes pertaining to the event, in the desired SoR. The new data can be quickly deployed to all relevant assets.

Other benefits include the following:

There is less toil on the application owner.

There is a better representation of asset risk—current application risk portfolio heavily leans towards critical & high-risk applications. A multi-layered risk rating allows for targeted control activities.

Updates are more timely—Rather than waiting for ½/3-year recertification cycles, results are updated when changes in underlying data are identified.

Accuracy is improved—Approved SoRs provide data rather than relying on authorizing official responses.

A graphical output tool is a portion of a device configured to, via an on-screen interface, visually communicate to a user information output by a device or application. A graphical input/output tool acts as both a graphical input tool and a graphical output tool. A graphical input and/or output tool may include, for example, screen-displayed icons, buttons, forms, or fields. Each time a user interfaces with a device, program, or system in the present disclosure, the interaction may involve any version of a user interface tool as described above, e.g., which may be a graphical user interface tool.

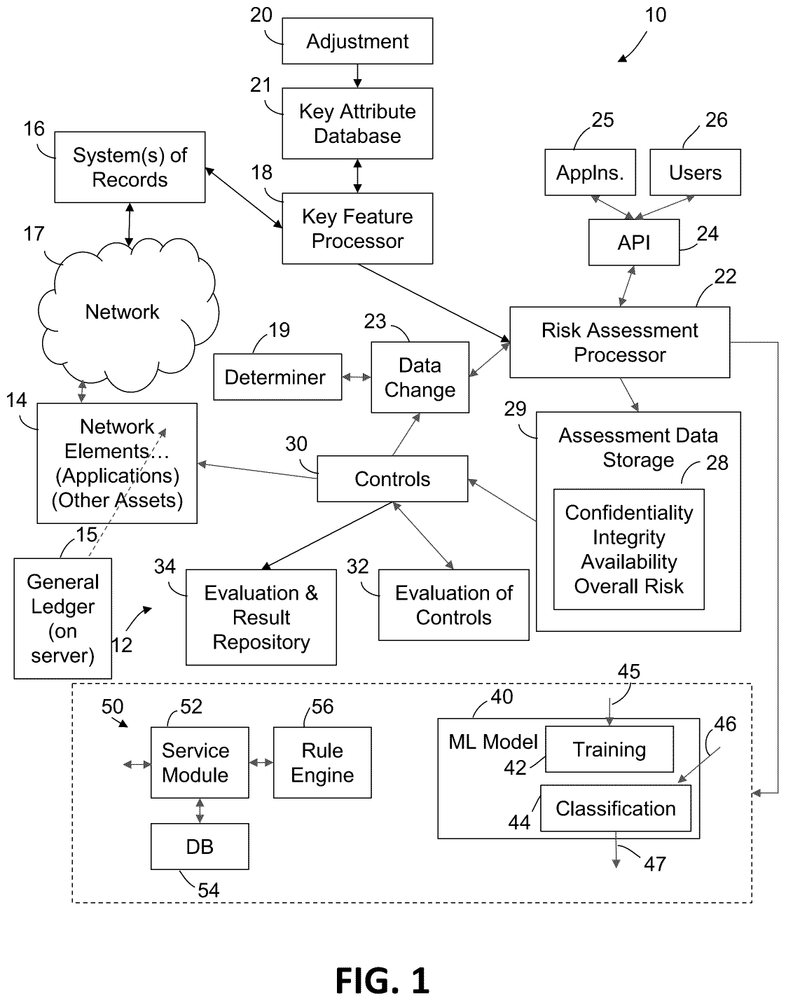

Referring to the drawings in further detail, FIG. 1 shows a block diagram of one embodiment of an organization's network and associated risk assessment system 10. The illustrated system 10 includes a network 17 comprised of network elements 14 to be assessed for risk. Network elements 14 in the illustrated embodiment comprise all the network devices forming part of a given secure information technology network. In alternate embodiments, network elements 14 may be limited to core assets of the network which are the applications of the network, to a subset of such core assets (applications), and/or to other assets.

The illustrated network includes an assessment and control subsystem 12, which generally comprises a risk assessment processor circuit 22, and a controls circuit 30. More specifically, subsystem 12 may also be considered to comprise a key feature processor 20 and assessment data storage 29 and other associated systems and circuits shown in FIG. 1 which are described below. Assessment data storage 29 is configured to store the assessment data associated with the asset network elements.

Risk assessment processor circuit 22 (more specifically, in a more specific embodiment, a classification circuit) is configured to access network element key features (from key feature processor 18 in the illustrated embodiment), and is further configured to provide, based at least in part on the accessed key features, assessment data 28 (stored in assessment data storage 29 per this illustrated embodiment). The assessment data 28 is associated with at least select ones of network elements forming managed information technology network 17. Assessment data storage 29 may comprise, for example, a database or more temporary storage, and is configured to hold the assessment data associated with the assessed network elements. Assessment data storage 29 may be accessed (written to and/or read from), for example, by the risk assessment processor circuit 22, controls circuit 30, and other portions of the illustrated system 10.

Assessment data 28 may comprise, on a per network element basis, feature data representing the following risk types: confidentiality risk, integrity risk, availability risk, and/or overall risk. These features may be in the form of categories for each risk type, of “critical”, “high” (less of a risk than “critical”), and “lower” (lower risk than a risk of “high”). Per another embodiment, these features for each risk type may be divided into “critical”, “high”, “medium”, and “low”. Per another embodiment, gradient values may be used to represent the different categories of risk for each risk type, for example, with magnitude at one end meaning a critical risk level and at another end meaning a lowest risk level. For example, integer number values 0-10 could be employed, with 0 representing the lowest risk level and 10 representing the highest risk level. Other types of features value systems could be used per other embodiments.

An application among network elements 14 may include a general ledger application 15 running on a server. General ledger application 15 may be configured to handle accounting books and records for an organization. When the general ledger application is assessed by the assessment processing circuit to have a given risk profile, for example, including high overall risk, the assessment processing circuit is configured to designate assessment data for the general ledger application to also correspond to the server on which the general ledger application is being run. Other example applications (not shown) may also be assessed, along with their servers, to have a given risk profile, for example, a high overall risk, and their servers in select embodiments are assigned the same risk profile. Those applications may include, for example, an equity trading revenue system application for calculating an amount of revenue earned from trading equities, and a credit card transaction system application that records transactions and calculates balances for all credit card customers.

Controls circuit 30 is configured to cause controls pertaining to at risk network elements 14. Some types of controls include controls for remediation, for mitigation, for monitoring, and for warning of one or more risks. Controls circuit 30 causes these controls to be placed on the network in accordance with the assessment data. Controls circuit 30 may also be configured to generate tickets for carrying out controls.

A key feature processor circuit 18 is provided that is configured to obtain key features from one or more SoRs of the organization. A key feature is a value or value set for an attribute of a given IT asset (for example, an application or other network element). More specifically, the key feature processing circuit is configured to provide the obtained key features required for risk assessment, by the risk assessment processor circuit 22, of a given individual or plural set of network elements 14.

An adjustment processor circuit 20 may be provided that is configured to adjust one or more attributes of the key attributes. Adjustment may involve adding, revising, or populating one or more key attributes. This adjustment to key attributes may be done in the one or more SoRs 16 or in a key attribute database 21 that may be provided in addition SoRs 16. An example added key attribute feature is geopolitical event data.

Risk assessment processor circuit 22 may be accessed by one or more applications 25 and human, artificial intelligence, or one or more otherwise at least partially automated users 26. In the embodiment, users 26 obtain access to risk assessment processor circuit 22 (in one embodiment run on a server) with the use of one or more applications 25 that interact with risk assessment processor circuit 22 via an application programming interface (API) 24.

Per one embodiment, risk assessment processor circuit 22 comprises a rule-based server 50, and users 26, using an application 25, access rule-based server 50 via API 24 connected to rule-based server 50. More specifically, in the embodiment shown in FIG. 1, rule-based server 50 includes a service module 52, a rule engine 56, and a database 54. Service module 52 interacts with users 26 via one or more applications 25 via API 24.

A user 26 or application 25 accesses service module 52 via an authorization and authentication process, and user 26 and/or application 25 may be located proximally or remotely from rule-based server 50. In one embodiment process, a client (given application or user) calls the service (on service module 52), and requests a required attribute (for example, personal information, a risk category) with values applicable for the requested attribute. A successful authentication and authorization is posted, and the service receives the provided attributes and values. The service triggers the execution of applicable rules in rule engine 56. Upon completion of rule execution, the service reads the output from rule engine 56 and passes it to the client with the version of the rule used to calculate the risk attribute along with any exceptions. The service will also log the request and response information.

In addition, or alternatively, from the illustrated rule-based server 50, risk assessment processor circuit 22 may comprise a machine learning (ML) model circuit 40. The illustrated ML model circuit 40 includes a training circuit 42 and a classification circuit 44. A training input 45, a classification input 46, and a classification output 47 are provided. A set of training features is input via training input 46 to train the model, and features from feature processor 18 are input via classification input 46 to classification circuit 44.

Application(s) 25 and risk assessment processor circuit 22 (e.g., ML model circuit 40, and/or rule-based server 50), may be configured to assign, in real-time or in fast recurring period time frames (e.g., every day, every hour, every minute), ratings as and when key attribute data is updated to the attribute data, for example, stored in SoRs 16.

In the case of an ML model circuit 40, gradient, multiple critical, high, medium, and low, or other risk category systems can be used to train machine learning models to draft targeted controls based on nuanced scenarios of risk rating systems. Controls can also be assigned and activated in real-time or in fast recurring period time frames as noted above.

The overall risk category described above, otherwise called an inherent risk, may be determined by risk assessment processor circuit 22, and help with prioritization based on risk severity and potential impact, helping an organization focus its resources on more critical assets. Apart from applications, the risk assessment and controls responding thereto can also be extended to other technological assets (forming part of network elements 14)—for example, share points, third-party websites, datasets, and machine learning models.

Risk assessments can be mapped to the resources of the organization, and the types and levels of controls for a given network element can be determined to meet regulatory, statutory, and organizational requirements. A control procedure scope definition may be provided, that indicates risk categories and associated controls therefor. This approach to risk rates for applications in some embodiments is based on three foundational principles in cybersecurity—confidentiality, integrity, and availability. A risk rating may be provided for each of these three risk types, and these risk ratings can be used to further refine control scope on confidentiality, integrity, and availability ratings of the network elements.

Controls circuit 30 may be provided with one or more control process circuits, and select one or more of those control process circuits may include one or more evaluation of controls circuits 32 configured to automatically review controls around SoR access, data quality of SoR, application profile creation/recertification controls, regulatory flags and subsequent triggering of findings/data quality tickets where the network element (e.g., a given application) does not meet control requirements. In addition, an evaluation and result repository 34 may be provided that serves as a repository of evidence of such reviews for future reference. For example, if an application changes to a cloud hosting platform, its risk assessment will change, and controls circuit 30 may be configured to automatically initiate a controls process as a result of that change.

Risk assessment processor circuit 22 may also be configured to determine a severity category (Sx) of an application and associated infrastructure assets. This severity category can in turn be used by risk assessment processor circuit 22 or another processor to determine service level agreement (SLA) data, for example, to set a number of days to respond to a given issue, related to a risk assessment or other determination associated with a given asset.

Risk assessment and other data such as Sx category may be utilized by auditors and regulators for determining samples during audit exams, to allow a focus on assets with higher assigned risk categories or severity which may therefore cause a material impact.

Per the example embodiment shown in FIG. 1, the confidentiality, integrity, and availability risks may more specifically be defined as follows: Confidentiality is defined as the intentional or malicious improper exposure of data (theft or driven by technology failure) to unauthorized parties. Integrity is defined as an intentional or malicious change or damage to data due to internal or external action and unintentional or accidental change or damage to data due to internal or external action.

Availability is vital to ensure timely and reliable access to information and its use. This includes Technology Assets (data or functionality) not available due to intentional or malicious action causing physical or non-physical damage, internal or external, as well as complete or partial destruction due to accidental action or major external incidents (i.e., natural disasters).

In addition to determining risks at risk assessment processor circuit 22, the same circuit or other processes—for example, controls processing circuit 30, may use the determined risks to determine regulatory scope and information confidentiality classification.

The system shown in FIG. 1 may be implemented, for example, providing multiple machines running risk assessment applications (or other applications with a need to interact with risk assessment processor circuit 22) 25 and/or with users 26 accessing the system via a web browser. Requests from each of these accessing identities may be submitted to a global load balancer (GLB) (not shown). The GLB may send the request to plural pools (not shown) in a cloud (not shown) to serve the request and reply with the response. The GLB passes the requests to the pools based on pool availability.

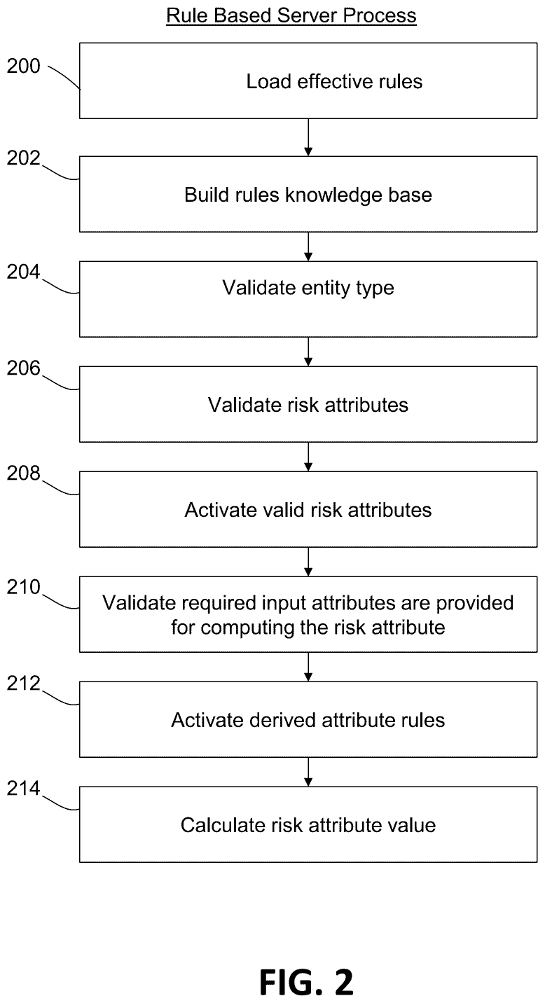

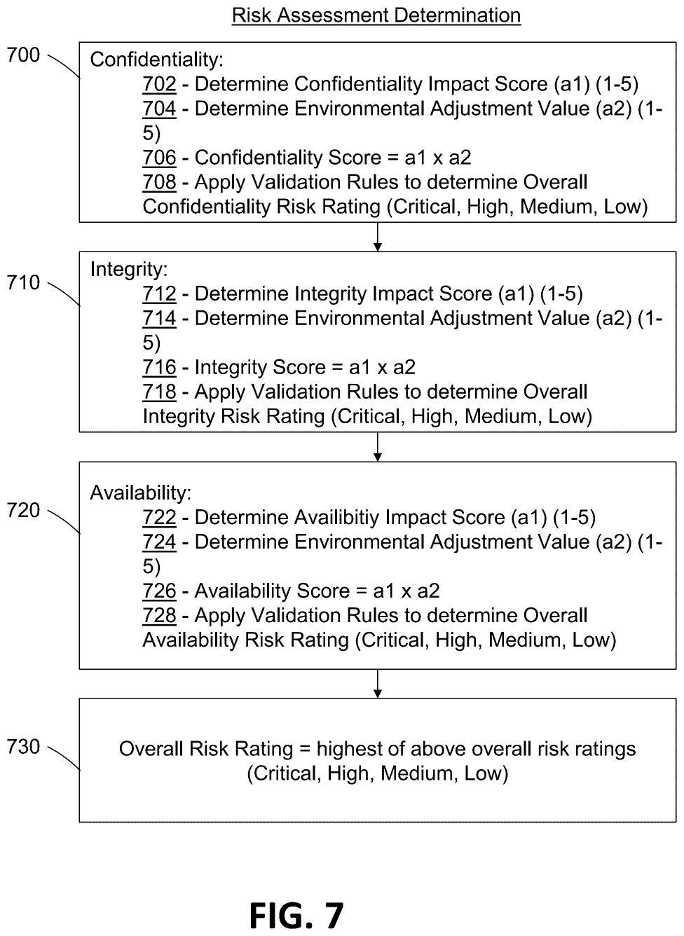

FIG. 2 shows a rule-based server process for rule-based server 50 shown in FIG. 1. At block 200, effective rules may be loaded. Effective rules are attribute rules in step 212, and more fully described below, for example, in connection with FIG. 7, with the risk rating matrix, or with the example embodiment following the introduction of the risk rating matrix.t When the rules are loaded, they are copied into processing memory.

At block 202, a rules knowledge base may be built, which may be a repository of data describing processes for acting on input data (attributes) and making determinations (assessments or determinations leading to assessments) therefrom. When executing the rule engine, initially, at block 204, an entity type (application or other network element) is validated. During validation the accuracy, structure, and integrity of the data for a given asset are checked.

If the entity type is validated, the process proceeds to block 206 at which the risk attributes are validated. During validation of the entity type, the accuracy, structure, and integrity of this data for a given asset are checked. These are the key attributes used to assess risk. If these are validated, the process proceeds to block 208 at which point the valid risk attributes are activated. At this step, raw data representing the risk attributes are transformed into actionable data inputs for subsequent application of the rules.

At block 210, the required input attributes are provided for computing the risk attribute, and this information is validated in the same manner data is validated in steps 204 and 206. If this information is validated, the process proceeds to block 212 where derived attribute rules are activated. At block 214, the risk attribute value is calculated, in a manner as described more fully in one of the embodiments described hereinbelow. Responses are now determined after block 214. It should be noted for any processes or flow charts herein, it is contemplated that blocks can be done at a different time or in a different order unless they depend on another previous block.

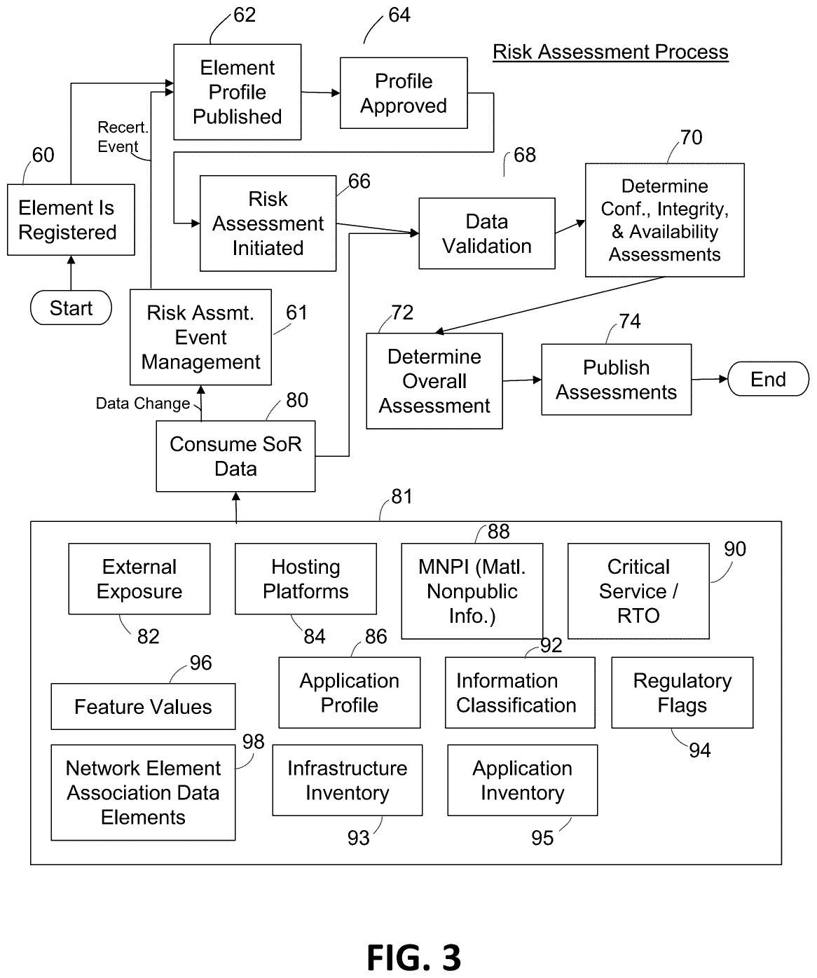

FIG. 3 is a flow chart of a risk assessment process that may be carried out, for example, by risk assessment processor circuit 22 in FIG. 1. Once the process starts, at block 60, a network element is registered. This is done for all network elements that will be considered for assessment, which in some embodiments is all the network's applications or a subset of the network's applications (sometimes called core assets), and in some embodiments also includes all or a subset of non-application (other) information technology assets forming parts of the network.

Whenever network entities, data elements, attributes, or features are defined, registered, published, approved, or validated in the process, this may occur when/as data is put in an SoR 16, by key feature processor 18 (and stored in key attribute database 21), or by risk assessment processor circuit 22—in accordance with alternative embodiments.

After a network element is registered, its profile is published at block 62. In block 64, the profile for a given network element is approved for assessment. Next, in block 66, risk assessment is initiated by the risk assessment circuit. In block 68, feature data to be used for determining assessments is validated, and in block 70, the assessment process (performed by the assessment circuit in the illustrated embodiment) determines confidentiality, integrity, and availability assessments. In block 72, an overall assessment is determined.

In block 74, the assessments determined in blocks 70 and 72 are published, which may involve storing the assessments in assessment data storage 29 and/or forwarding the assessments to controls circuit 30 for prompting and/or configuring of controls (e.g., risk mitigation) processes. Per one embodiment, controls circuit 30 may monitor for changes to assessment data storage 29 or for publishing of assessments by risk assessment processor circuit 22 (block 74) and upon such changes being identified, automatically commence a controls process for mitigation, for example, a vulnerability scan or penetration testing.

Per an embodiment involving a penetration scanning process automatically commenced (or setup awaiting human input for execution), planning, scanning, access, and access assessment are performed. With planning, one or more systems are identified to be tested, testing methods are identified, and data is gathered about the targeted system or systems. With scanning, a static analysis is performed (inspecting the code of the target) and a dynamic analysis is performed (inspecting the code in a running state). With access, the target is accessed, for example, with a web application attack. With access assessment, the penetration scanning process determines extent of access, and determines whether a persistent presence can be established. At the conclusion of the penetration scanning process, the risk level data for the relevant network elements may be updated-providing more nuanced additional features or upgrading an assessment of, for example, overall risk to critical or downgrading depending on the results.

At block 80, the process consumes SoR data input from data storage 81. Specifically, feature values 96 for network elements to be assessed (data for which is stored as network element association data elements 98) is consumed and provided for data validation at block 68. In addition, feature values 96 are monitored for data changes, which are input to risk assessment event management block 61. Risk assessment event management block 61 causes block 62 to be performed at which point the revised and updated network element is published.

Feature values 96 are obtained from various key attributes including data about external exposure 82, hosting platforms 84, material nonpublic information (MNPI) 88, critical service and Recovery Time Objective (RTO) data 90, application profile data 86, information classification data 92, regulatory flags 94, infrastructure inventory data 93, and application inventory data 95.

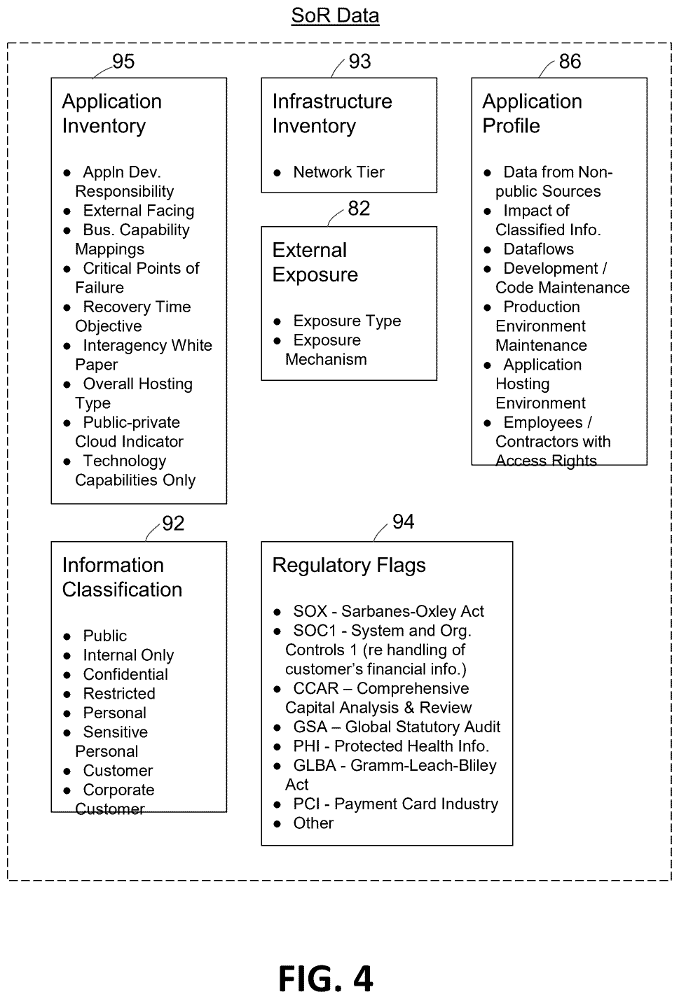

More specifically, certain data types may be deemed key attributes relevant to determining the various risk ratings determined by risk assessment processor circuit 22. Such data types may include those specific data types shown in FIG. 4, depicting sample key attributes. These key attributes may be utilized as further described hereinbelow, in determining assessments. For example, application inventory attributes 95 may include the following:
Application Development Responsibility,
External Facing,
Business Capability Mappings,
Critical Points of Failure,
Recovery Time Objective,
Interagency White Paper,
Overall Hosting Type,
Public-private Cloud Indicator,
Technology Capabilities Only,
Infrastructure inventory attributes 93 may include Network Tier.
External exposure attributes 82 may include Exposure Type and Exposure Mechanism.
Application profile attributes 86 may include the following:
Data from Non-public Sources,
Impact of Classified Information,
Dataflows,
Development/Code Maintenance,
Production Environment Maintenance,
Application Hosting Environment,
Employees/Contractors with Access Rights,
Information classification attributes 92 may include the following:
Public
Internal Only
Confidential
Restricted
Personal
Sensitive Personal
Customer
Corporate Customer
Regulatory Flags attributes 94 may include the following:
SOX—Sarbanes-Oxley Act
SOC1—System and Org. Controls 1 (re handling of customer's financial info.)
CCAR—Comprehensive Capital Analysis & Review
GSA—Global Statutory Audit
PHI—Protected Health Info.
GLBA—Gramm-Leach-Bliley Act
PCI—Payment Card Industry
Other

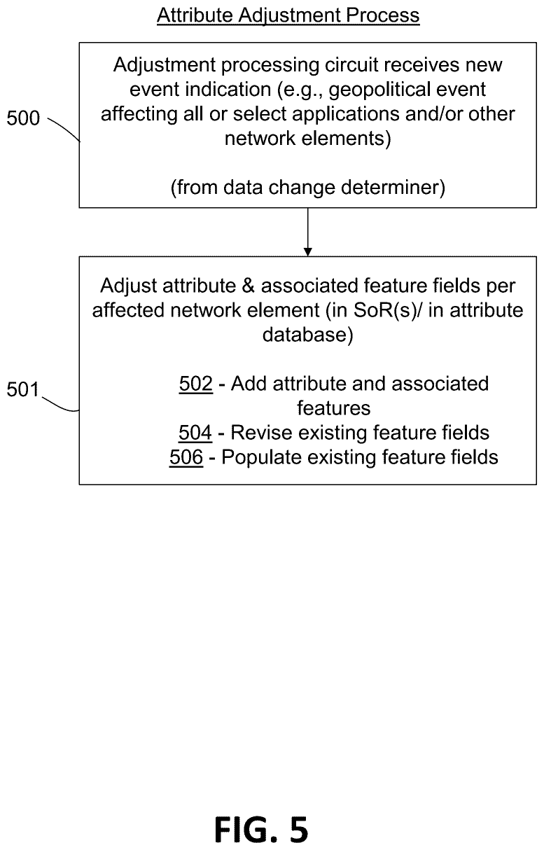

FIG. 5 is a flow chart of an attribute adjustment process carried out by adjustment processing circuit 20. At block 500, adjustment processing circuit 20 receives a new event indication. For example, it may receive this indication and data associated with a geopolitical event affecting all or select applications and/or other network elements. This indication may be received from a monitoring circuit external to system 10, or from another circuit within system 10, e.g., determiner 19.

In block 501, one or more associated attributes and associated features are adjusted per the affected network element, in SoRs 16 and/or key attribute database 21. This may involve adding one or more attributes and associated features at block 502, revising existing feature fields at block 504, and/or populating existing feature fields at block 506.

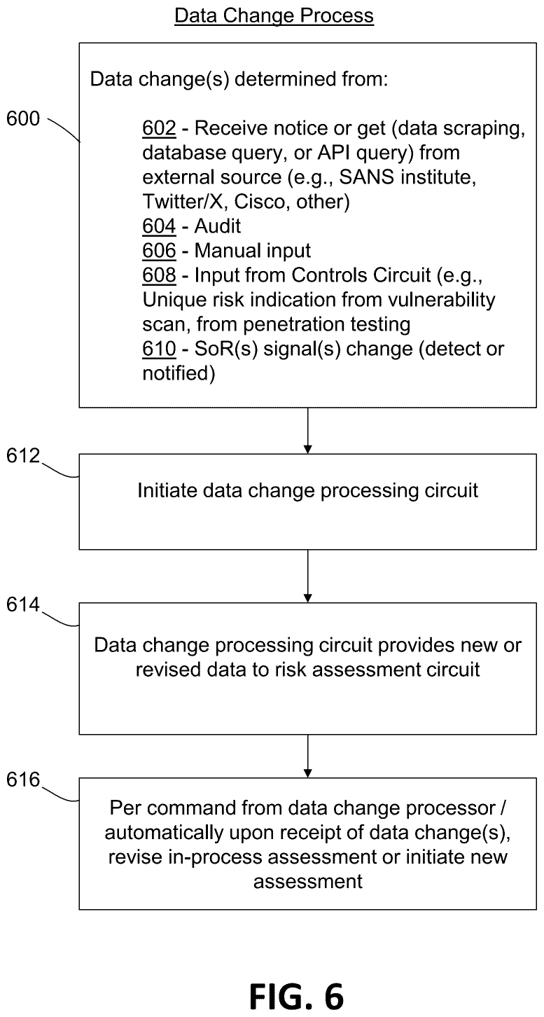

FIG. 6 is a flow chart of a data change process that may be carried out by determiner 19 and data change circuit 23. In block 600, one or more data changes are determined by determiner 19. These data changes may be determined in block 602 where the determiner receives a notice or gets an indication and data (e.g., via data scraping, database query, or API query) from an external source (e.g., SysAdmin, Audit, Network, and Security (SANS) institute, Twitter/X, Cisco, and others).

The data changes may be determined in block 604—Audit, in block 606—Manual input, in block 608—Input from Controls Circuit (e.g., unique risk indication from vulnerability scan, from penetration testing), or in block 610—SoR signal(s) change (detected, for example, by the determiner, or the determiner is notified).

In block 612, data change processing circuit 23 is initiated. In block 614, data change processing circuit 23 provides new or revised data to risk assessment processor circuit 22. In block 616, per a command from data change processing circuit 23, or automatically upon receipt of data change(s), an in-process assessment being performed by the risk assessment processor circuit 22 is revised, or a new assessment is initiated.

FIG. 7 is a flow chart of one embodiment of a risk assessment determination process. In block 700, a confidentiality risk rating is determined. More specifically, within block 700, block 702 determines a confidentiality impact score (a1) (integer ranging from 1 to 5). Block 704 determines environmental adjustment value (a2) (integer ranging from 1 to 5). In block 706, confidentiality score=a1×a2. In block 708, validation rules are applied to determine overall confidentiality risk rating (critical, high, medium, low).

Block 710 determines an integrity risk rating. Within block 710, block 712 determines an integrity impact score (a1) (integer ranging from 1 to 5). Block 714 determines an environmental adjustment value (a2) (integer ranging from 1 to 5). In block 716, an exemplary integrity score=a1×a2. In block 718, validation rules are applied to determine overall integrity risk rating (critical, high, medium, low).

In block 720, an availability risk rating is determined. More specifically, within block 720, an availability impact score is determined as (a1) (integer ranging from 1 to 5), in block 722. An environmental adjustment value (a2) (integer ranging from 1 to 5) is determined in block 724. In block 726, an availability score=a1×a2. In block 728, validation rules are applied to determine an overall availability risk rating (critical, high, medium, low). Overall risk rating=highest of above overall risk ratings (critical, high, medium, low).

In block 730, an overall risk rating is determined. These determinations are made for each network element being assessed.

The risk determination process shown in FIG. 7 may utilize the following 5×5 risk rating matrix to determine a risk rating for classification of a given network element, e.g., an application. The impact score (1 to 5) is multiplied by the environmental adjustment (likelihood) score (1 to 5) to calculate the risk score anywhere between 1 and 25. Business validation rules (referenced at steps 708, 718, and 728 in the process shown in FIG. 7) may be cross-checked, and a given network element may be assigned a critical, high, medium, or low risk rating. The validation rules set a minimum risk rating for certain key features.

### Risk Rating Matrix:

| Likelihood (Environ- | M | M | H | H | C |
|---|---|---|---|---|---|
| mental Adjustments) | (5) | (10) | (15) | (20) | (25) |
| | L | M | M | H | H |
| | (4) | (8) | (12) | (16) | (20) |
| | L | L | M | M | H |
| | (3) | (6) | (9) | (12) | (15) |
| | L | L | L | M | M |
| | (2) | (4) | (6) | (8) | (10) |
| | L | L | L | L | M |
| | (1) | (2) | (3) | (4) | (5) |

Impact

The following discussion provides more information regarding scoring methodology that may be employed for risk ratings by the risk assessment circuit, in a particular example embodiment. The calculations described below include a distinct rating for each Confidentiality, Integrity, and Availability component and an overall combined risk rating. In this example, for Confidentiality and Integrity only, results are also multiplied by Environmental considerations when determining an initial risk score. In each component, minimum thresholds adjustments (described above and also called validation rules) are applied for certain business scenarios. The highest Confidentiality, Integrity, and Availability component risk score is applied to the overall application risk rating.

### Confidentiality Scoring Methodology Overview:

### Confidentiality—Impact Consideration:

a) Scoring focuses on information confidentiality classification (Highly Confidential, Confidential, Public, or Internal) with Highly Confidential and MNPI the highest risk.
b) Other attributes include impact of classified data if compromised, personal information, and protected health information.
c) Scoring has a 1-5 range based on attributes scored with 5 being highest.

### Confidentiality Environmental Consideration:

a) Scoring includes considerations of external exposure.
b) Business partner connectivity and exposure mechanisms.
c) Third-party data centers.
d) Network tier.
e) Scoring has a 1-5 range based on attributes scored with 5 being highest.

### Confidentiality—Business Consideration—Minimum Threshold:

a) MNPI automatically considered critical.
b) Regulatory driven payment card industry (PCI)/Gramm-Leah-Bliley Act (GLBA)/Health Insurance Portability and Accountability Act (HIPPA), etc.—no lower than medium.
c) Information confidentiality classification (highly confidential or confidential) no lower than medium.

### Confidentiality Risk Rating:

$$Score 25 = Critical . \qquad a )$$

$$Score 15 - 24 = High . \qquad b )$$

$$Score 7 - 14 = Medium . \qquad c )$$

$$Score 1 - 6 = Low . \qquad d )$$

### Integrity Scoring Methodology Overview:

### Integrity—Impact Consideration:

a) Score focuses on the business impact of data integrity.
b) Examples include: Global Financial Statements, for example, Sarbanes-Oxley Act (SOX), High Value Business Entitlements (HVBE), and Customer Impacted processes, for example, Statement on Standards for Attestation Engagements (SSAE).
c) Scoring has a range of 1-5 based on attributes scored with 5 being the highest.

### Integrity—Environmental Consideration:

a) Scoring includes considerations of external exposure.
b) Business partner connectivity and exposure mechanisms.
c) Third-party data centers.
d) Network tier.
e) Scoring has a range of 1-5 based on attributes scored with 5 being the highest.

### Integrity—Business Considerations—Minimum Threshold:

a) IWP (Inter-Agency White Paper) (regulatory reporting) automatically critical.
b) SOX (Sarbanes-Oxley Act), system, and organization controls 1 (SOC1), Comprehensive Capital Analysis and Review (CCAR), etc., no lower than medium.

### Integrity Risk Rating:

$$Score 25 = critical . \qquad a )$$

$$Score 15 - 24 = high . \qquad b )$$

$$Score 7 - 14 = medium . \qquad c )$$

d) Score 1-6=low.

### Availability Scoring Methodology Overview:

a) Scoring focuses on Critical Point of Failure (CPOF) to an essential services and Recovery Time Objective (RTO)
b) Scoring follows a direct alignment. No additional calculation.
   Availability—business consideration limits:
a) RTO of 2 hours or less are automatically critical

Availability risk rating: critical, high, medium, or low.

Overall risk rating scoring methodology. The overall risk rating is set to be the highest rating from the confidentiality, integrity, and availability ratings, and, in this embodiment, may be critical, high, medium, or low.

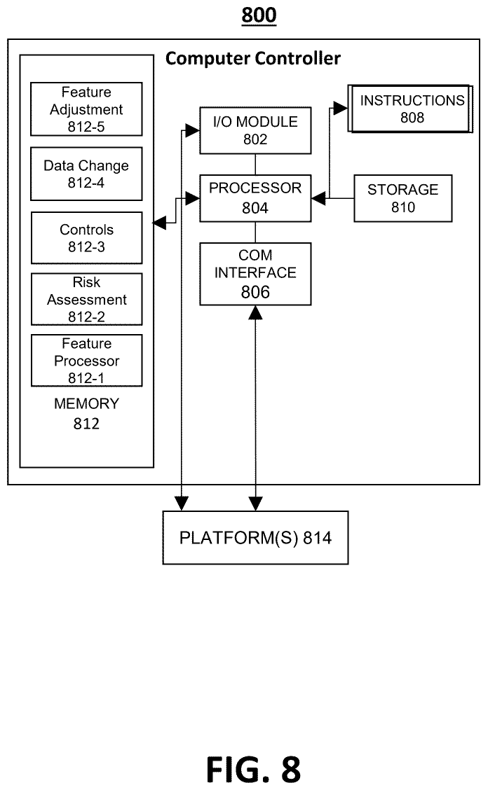

FIG. 8 illustrates a computer controller 800 that may be an application-specific hardware, software, and firmware implementation of one or more aspects of system 10 in FIG. 1, described above. The controller 800 may include a processor configured to be executed one or more, or all of the blocks of the circuit of FIG. 1, or the functions of the exemplary system 10, described above.

The processor 804 can have a specific structure imparted to the processor 804 by instructions stored in the memory 812 and/or by instructions 808 fetchable by the processor 804 from a storage medium 810. The storage medium 810 can be remote and communicatively coupled to the controller 800.

The controller 800 can be a stand-alone programmable system, or a programmable module included in a larger system. For example, the controller 800 may include or be connected with the system 10. For example, the controller 800 may include one or more hardware and/or software components configured to fetch, decode, execute, store, analyze, distribute, evaluate, and/or categorize information.

The processor 804 may include one or more processing devices or cores (not shown). In some embodiments, the processor 804 may be a plurality of processors, each having either one or more cores. The processor 804 can execute instructions fetched from the memory 812, i.e., from one of memory modules 812-1, 812-2, 812-3, 812-4, or 812-5. Alternatively, the instructions can be fetched from the storage medium 810, or from a remote device connected to the controller 800 via the communication interface 806. Furthermore, the communication interface 806 can also interface with computer systems within a computer system of the system 10. An input/output (I/O) module 802 may be configured for additional communications with associated remote systems of a host 814 of the system 10.

Without loss of generality, the storage medium 810 and/or the memory 812 can include a volatile or non-volatile, magnetic, semiconductor, tape, optical, removable, non-removable, read-only, random-access, or any type of non-transitory computer-readable computer medium. The storage medium 810 and/or the memory 812 may include programs and/or other information usable by processor 804. Furthermore, the storage medium 810 can be configured to log data processed, stored, or collected during operation of controller 800.

The data may be time-stamped, location-stamped, cataloged, indexed, encrypted, and/or organized in a variety of ways consistent with data storage practice. By way of example, the memory module 812-1 may represent a specialized module configured to implement aspects of the feature processor 18, described above. Similarly, the memory module 812-2 may form a specialized risk assessment process module, the memory module 812-3 may form a specialized controls module, the memory module 812-4 may form a specialized data change module, and the memory module 812-5 may form a specialized feature adjustment module. The instructions embodied in these memory modules can cause the processor 804 to perform certain operations consistent with the functions described above.

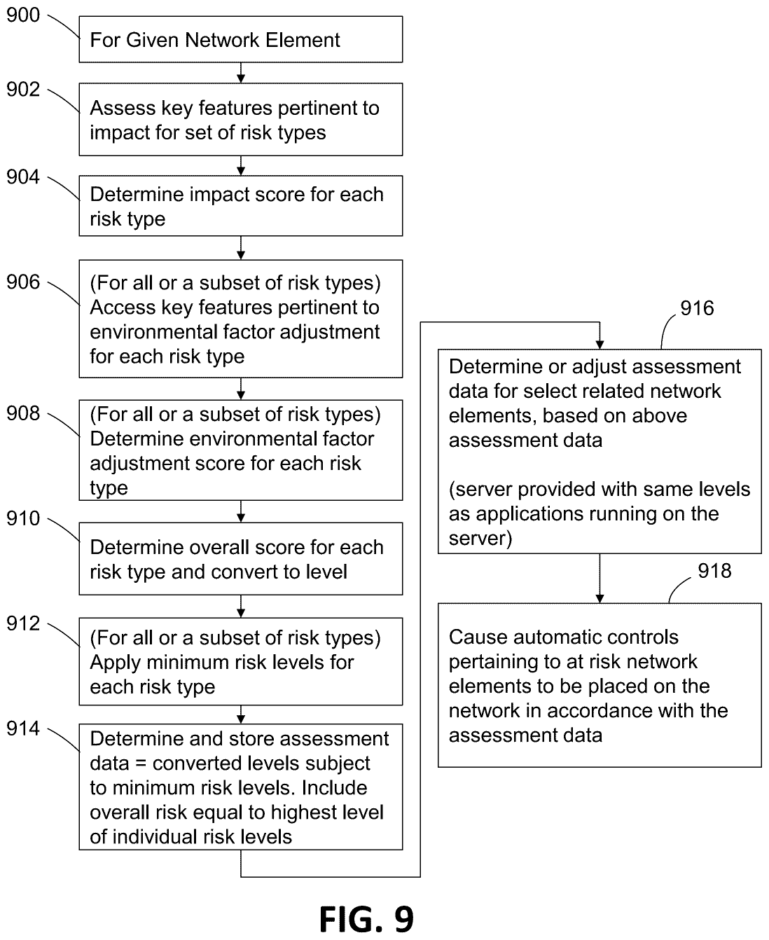

FIG. 9 is a flow chart of aspects of an exemplary method carried out by a risk assessment system, for example, the system shown in FIG. 1. More specifically, steps 900-916 may be performed by risk assessment processing circuit 22, while step 918 may be performed by controls circuit 30. At step 900, the process, carried out by the risk assessment processing circuit 22 shown in FIG. 1, is carried out for a given network element, until all network elements to be assessed are processed. The assessment process may be configured to process all network elements in the network 17, or it may be configured to focus on certain types of network elements or a subset, for example, as explained hereinabove.

At step 902, key features are accessed that are pertinent to impact for a set of risk types. In the illustrated embodiment, the set of risk types includes confidentiality, integrity, and availability. For example, for the confidentiality risk type, in the embodiments described above, key features indicating confidentiality classifications (see features 92 shown in FIGS. 3 and 4 discussed above), MNPI (Material Nonpublic information) are accessed for determining their impact. More specifically, as mentioned at step 904, an impact score is determined for these key features.

For the integrity risk type, the key features that are accessed at step 902 to determine impact score at step 904, include, for example, Global Financial Statements, for example, Sarbanes-Oxley Act (SOX), High Value Business Entitlements (HVBE), and Customer Impacted processes, for example, Statement on Standards for Attestation Engagements (SSAE).

For the availability risk type, key features that are accessed at step 902 to determine impact score at step 904, include, for example, Critical Point of Failure (CPOF) to an essential services and Recovery Time Objective (RTO).

Per step 906, for all or a subset of the risk types, key features are accessed that are pertinent to environmental factor adjustment for each risk type. For example, this occurs for only the confidentiality and availability risk types in the embodiment described above after the risk rating matrix, and for all risk types in the embodiment described above with reference to the risk rating matrix. In the next step 908, environmental factor adjustment scores are determined for each risk type.

Key features pertaining to environmental factor adjustment, for any risk type, may include, in select embodiments, data concerning external exposure, business partner connectivity and exposure mechanisms, third-party data centers, and network tier information.

At step 910, the scores determined are used to determine an overall score for each risk type, and the overall score is converted to a level of risk as more fully described above. Per one embodiment, the levels may be low, medium, high, and critical. When impact scores and environmental adjustment scores are each considered, in select embodiments, those scores have an integer numerical value between 1 and 5 and are multiplied together to provide an overall score value. Per one embodiment, the risk rating matrix above may be used to use the overall score to determine the level of risk.

Per step 912, minimum risk levels are applied to the levels determined at step 910, in the event the key features utilized to determine the different risk type scores have certain values. For the different risk types, example key features and associated minimum risk levels are specified above.

At step 914, assessment data is determined and stored. The assessment data includes the converted levels subject to the minimum risk levels, and further includes an overall risk that is equal to the highest level of the individual risk type levels.

At step 916, as more fully described above, a determination or adjustment is made by the assessment processing circuit for select related network elements, based on the assessment data already determined. For example, a server will be provided with the same levels as applications running on the server. If more than one application is run on the server, and those applications have different risk levels, the highest among those application risk levels will be attributed to the server.

At step 918, the control circuit is caused to automatically carry out controls on the network, when one or more network elements are deemed at risk, for example, when they are assessed to have a high or critical risk. Features related to this step are described more fully above.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

While the foregoing is directed to embodiments of the present disclosure, other and further embodiments of the disclosure may be devised without departing from the basic scope thereof, and the scope thereof is determined by the claims that follow.

What is claimed is:

1. Apparatus comprising:
a risk assessment processing circuit configured to access network element key features, and configured to provide, based at least in part on the accessed key features, assessment data associated with at least select ones of network elements forming a given managed information technology network, wherein the risk assessment processing circuit is configured to, for each select network element among plural network elements in the network: (i) access key features pertinent to a set of risk types, (ii) determine an impact score for each of the risk types, (iii) determine an overall score for each of the risk types, and (iv) convert the overall score for each of the risk types to a risk level, and determine the assessment data to include the risk levels converted from the overall scores;
a control circuit configured to cause controls pertaining to at risk network elements to be placed on the network in accordance with the assessment data; and
assessment data storage configured to hold the assessment data associated with the assessed network elements.

2. The apparatus according to claim 1, wherein the risk assessment processing circuit is further configured to, for each select network element among plural network elements in the network, (v) access key features pertinent to environment factor adjustment for each risk type, (vi) determine an environmental factor adjustment score for respective risk types of at least a subset of the set of risk types, wherein the determined overall score for a given risk type from among each of the risk types is determined based on both the impact score for the given risk type and the environmental factor adjustment score for the given risk type.

3. The apparatus according to claim 1, wherein the risk assessment processing circuit is further configured to, for each select network element among plural network elements in the network, (vii) apply minimum risk levels for a given risk type when select accessed key features were utilized to determine a level for the given risk type.

4. The apparatus according to claim 3, wherein the network elements comprise core and non-core assets of the network.

5. The apparatus according to claim 1, wherein the assessment data comprises, per assessed network element, feature data representing confidentiality risk type levels.

6. The apparatus according to claim 1, wherein the assessment data comprises, per assessed network element, feature data representing integrity risk type levels.

7. The apparatus according to claim 1, wherein the assessment data comprises, per assessed network element, feature data representing availability risk type levels.

8. The apparatus according to claim 1, wherein the assessment data comprises, per assessed network element, feature data representing overall risk levels.

9. The apparatus according to claim 1, wherein the assessment data comprises, per assessed network element, feature data representing confidentiality, integrity, availability, and overall risk levels.

10. The apparatus according to claim 9, wherein the risk assessment processing circuit is configured to assess a given core asset comprising an application.

11. The apparatus according to claim 10, wherein the application comprises a general ledger application configured to carry out accounting and bookkeeping for an organization, wherein when the general ledger application is assessed by the assessment processing circuit to have a high overall risk level, wherein the assessment processing circuit is configured to designate assessment data for the general ledger application to also correspond to a server on which the general ledger application is being run.

12. The apparatus according to claim 11, wherein the assessment processing circuit is configured to determine that the overall risk rating for a given network element is critical when any one of the confidentiality, integrity, and availability risk ratings for the given network element is critical.

13. The apparatus according to claim 1, further comprising a key feature processor configured to obtain key features from one or more systems of records of the organization, wherein a key feature is a value or value set for an attribute of a given information technology asset, and configured to provide the obtained key features required for risk assessment by the risk assessment circuit of a given individual or plural set of network elements.

14. The apparatus according to claim 1, further comprising an adjustment processing circuit configured to adjust one or more attributes of the key attributes.

15. The apparatus according to claim 14, wherein the adjustment processing circuit is configured to add geopolitical event data as an added key attribute and associated feature.

16. The apparatus according to claim 1, further comprising a data change determiner and a data change processing circuit, wherein the data change determiner is configured to determine when a relevant data change has occurred since a last assessment relevant to risk assessment by the risk assessment circuit.

17. The apparatus according to claim 16, wherein the data change determiner is configured to determine a relevant data change from an external source external to the given managed information technology network.

18. The apparatus according to claim 16, wherein the data change determiner is configured to determine a relevant data change from feedback input from the controls circuit when the controls circuit determines that a given application should be upgraded to a critical rating as a result of a vulnerability scan.

19. A method comprising:
accessing, by a risk assessment processing circuit, network element key features, and providing, by the risk assessment processing circuit, based at least in part on the accessed key features, assessment data associated with at least select ones of network elements forming a given managed information technology network, wherein, for each select network element among plural network elements in the network: (i) key features are accessed pertinent to a set of risk types, (ii) impact score is determined for each of the risk types, (iii) an overall score is determined for each of the risk types, and (iv) the overall score is determined for each of the risk types to a risk level, and the assessment data is determined to include the risk levels converted from the overall scores;
causing, by a control circuit, controls pertaining to at risk network elements to be placed on the network in accordance with the assessment data; and
holding, in assessment data storage, the assessment data associated with the assessed network elements.

20. A non-transitory computer-readable media encoded to cause:
accessing, by a risk assessment processing circuit, network element key features, and providing, by the risk assessment processing circuit, based at least in part on the accessed key features, assessment data associated with at least select ones of network elements forming a given managed information technology network, wherein, for each select network element among plural network elements in the network: (i) key features are accessed pertinent to a set of risk types, (ii) impact score is determined for each of the risk types, (iii) an overall score is determined for each of the risk types, and (iv) the overall score is determined for each of the risk types to a risk level, and the assessment data is determined to include the risk levels converted from the overall scores;
causing, by a control circuit, controls pertaining to at risk network elements to be placed on the network in accordance with the assessment data; and
holding, in assessment data storage, the assessment data associated with the assessed network elements.
